(19) United States
(12) Patent Application Publication
(10) Pub. No.: US 2019/0363901 A1
(43) Pub. Date: Nov. 28, 2019

(54) MANAGEMENT METHOD AND MANAGEMENT SYSTEM FOR MANAGING TARGET DEVICE

(71) Applicant: Yi-Pang Hung, Taipei City (TW)

(72) Inventor: Yi-Pang Hung, Taipei City (TW)

(21) Appl. No.: 15/987,221

(22) Filed: May 23, 2018

(51) Int. Cl. H04L 12/28; G05B 15/02

(52) U.S. Cl. CPC H04L 12/282; G05B 15/02; H04L 12/2827

(57) ABSTRACT

A management system includes a management host device and at least one mobile device, and the management host device executes a management method. The management host device executes a normal mode, a temporary mode, and an unmanned mode. In the normal mode, the management host device broadcasts a first connection signal. In the temporary mode, the management host device broadcasts a second connection signal. When the mobile device receives the second connection signal, the mobile device transmits a resume command to the management host device. When the management host device receives the resume command, the management host device executes the normal mode instead. When the management host device does not receive the resume command, the management host device executes the unmanned mode instead. Therefore, the management host device can automatically control at least one target device to be turned on or off, thereby avoiding unnecessary power waste or safety concerns.

### BACKGROUND OF THE INVENTION

### 1. Field of the Invention

The present invention relates to a management method and a management system, and more particularly to a management method and a management system for managing at least one target device.

### 2. Description of the Related Art

Nowadays, people live with a variety of electrical appliances. For example, there are computers, electric fans, air conditioning equipments, electric lights and other electrical appliances in the office; there are televisions, computers, fans, air conditioning equipments, electric lights, water heaters, refrigerators and other electrical appliances at home.

However, these electrical appliances must rely on electricity to operate. When the user is using the electrical appliances, the electrical appliances start normal operation and consume power. When the user leaves without continuing using the electrical appliances, the user must turn off the appliances or control the electrical appliances to enter the standby state to reduce the power consumption and prevent waste of the power. However, if the user rushes to leave and forgets to turn off the electrical appliances, the electrical appliances will continue to operate, causing unnecessary waste of power.

In addition, the user may leave without turning off the electrical appliances because of other matters. This not only results in waste of electricity, but also may cause accidents. For example, if a heater is continuously operating, the heater may malfunction. But, when there is no one present to handle the malfunction of the heater, a fire accident may be caused by the malfunction of the heater

Furthermore, in general, a security monitoring system at home or in the office is constantly operating throughout the day to perform home and office security monitoring to ensure the safety of home or office. However, a non-stop operation of the security monitoring system will cause considerable power consumption. Therefore, the security monitoring system can be turned on or off by the user to reduce the power consumption of the security monitoring system.

Since the user of the security monitoring system wishes to maintain personal privacy, the user can turn off a monitoring video-recording of the security monitoring system when the user stays at home or in the office. When the user goes out, the user manually turns on the security monitoring system.

However, the security monitoring system mainly provides security monitoring when no one stays at home or in the office. If the user goes out and forgets to turn on the security monitoring system to set an alarm, the security monitoring of the security monitoring system is virtually nullified.

Further, a smart window controller is used to control the windows in the user's home or office. When the user is at home or in the office, the user can remotely control the windows to be opened or closed through a remote controller or a mobile device. However, if the user forgets to control the window to be closed after the user goes out, rain will splatter an interior of home or the office and damage the furniture.

Since the user needs to manually turn on or off the electrical appliances or the control system, the user may usually forget to turn on or off the electrical appliances or control system when the user goes out, or the user may rush to leave and forget to turn on or off the electrical appliances. As a result, unnecessary power waste will be caused, or the user forgets to turn on the security monitoring system, causing safety concerns, or the user forgets to close the window, causing damage to the furniture by rain splashing. Therefore, the common method for controlling the electrical appliances needs to be further improved.

### SUMMARY OF THE INVENTION

An objective of the present invention is to provide a management system and a management method for managing at least one target device. The management system and the management method may automatically control the at least one target device to turn on or off according to whether or not the user leaves, thereby reducing power consumption.

The management method for managing the at least one target device is executed by a management host device, and the management method includes the steps of:

executing a normal mode;

in the normal mode, resetting time of a timing unit, and turning on the timing unit to start timing;

broadcasting a first connection signal; wherein the first connection signal includes a first connection tag;

determining whether the time of the timing unit exceeds a first preset time period;

when the time of the timing unit exceeds the first preset time period, executing a temporary mode instead;

in the temporary mode, resetting the time of the timing unit, and turning on the timing unit to start timing;

in the temporary mode, stopping broadcasting the first connection signal, and broadcasting a second connection signal instead; wherein the second connection signal includes a second connection tag;

determining whether a resume command transmitted by a mobile device is received; wherein
when the resume command is received, executing the normal mode instead;
when the resume command is not received, determining whether the time of the timing unit exceeds a second preset time period; wherein
   when the time of the timing unit does not exceed the second preset time period, continuously broadcasting the second connection signal, and determining again whether the resume command is received;
   when the time of the timing unit exceeds the second preset time period, executing an unmanned mode instead;

wherein

in the normal mode, producing at least one normal mode control signal to control a startup state of the at least one target device; in the unmanned mode, producing at least one unmanned mode control signal to change the startup state of the at least one target device;

in the normal mode, when the time of the timing unit does not exceed the first preset time period, continuously broadcasting the first connection signal, and determining again whether the time of the timing unit exceeds the first preset time period.

The management system includes at least one mobile device and a management host device.

The management host device includes a timing unit, and executes a normal mode. When the management host device executes the normal mode, the management host device resets time of the timing unit, turns on the timing unit to start timing, and broadcasts a first connection signal. The first connection signal includes a first connection tag. The management host device further determines whether the time of the timing unit exceeds a first preset time period. When the management host device determines that the time of the timing unit exceeds the first preset time period, the management host device executes a temporary mode instead.

When the management host device executes the temporary mode, the management host device resets the time of the timing unit, turns on the timing unit to start timing, stops broadcasting the first connection signal, and broadcasts a second connection signal instead. The second connection signal includes a second connection tag. The management host device further determines whether a resume command transmitted by the at least one mobile device is received.

When the management host device executes the temporary mode, and when the management host device receives the resume command, the management host device executes the normal mode instead.

When the management host device executes the temporary mode, and when the management host device does not receive the resume command, the management host device determines whether the time of the timing unit exceeds a second preset time period.

When the management host device executes the temporary mode, and when the management host device determines that the time of the timing unit does not exceed the second preset time period, the management host device broadcasts again the second connection signal, and determines again whether the resume command is received.

When the management host device executes the temporary mode, and when the management host device determines that the time of the timing unit exceeds the second preset time period, the management host device executes an unmanned mode instead.

When the management host device executes the normal mode, the management host device generates at least one normal mode control signal to control a startup state of the at least one target device. When the management host device executes the unmanned mode, the management host device generates at least one unmanned mode control signal to change the startup state of the at least one target device.

When the management host device executes the temporary mode or the unmanned mode, the management host device determines whether or not to execute the normal mode by determining whether the resume command is received. Moreover, the management host device determines whether to stop executing the normal mode to execute the temporary mode by determining whether the time of the timing unit exceeds the first preset time period, and the management host device further determines whether to stop executing the temporary mode to execute the unmanned mode by determining whether the time of the timing unit exceeds the second preset time period.

Therefore, the management host device can determine whether the user is in the vicinity of the management host device by determining whether the resume command is received, and the management host device can also determine which mode needs to be executed by determining whether the resume command is received. Then, the management host device can automatically turn on or off the at least one target device according to the mode currently executed by the management host device. In this way, unnecessary power waste can be avoided, safety concerns can be avoided, and the furniture can be prevented from being splashed with rain.

### BRIEF DESCRIPTION OF THE DRAWINGS

FIG. 1 is a block diagram of an embodiment of a management system of the present invention for controlling at least one target device;

FIGS. 2A and 2B are flowcharts of a first embodiment of a management method of the present invention for controlling at least one target device;

FIGS. 3A and 3B are flowcharts of a first embodiment of a connection procedure of a management method of the present invention for controlling at least one target device;

FIGS. 4A and 4B are flowcharts of a second embodiment of the connection procedure of the management method of the present invention for controlling the at least one target device;

FIG. 5 is flowchart of an embodiment of a host registration procedure of a management method of the present invention for controlling at least one target device;

FIGS. 6A and 6B are flowcharts of a first embodiment of a management procedure executed by at least one mobile device of a management system of the present invention for controlling at least one target device;

FIGS. 7A and 7B are flowchart of an embodiment of a device registration procedure executed by at least one mobile device of a management system of the present invention for controlling at least one target device;

FIGS. 8A and 8B are flowcharts of a second embodiment of a management method of the present invention for controlling at least one target device;

FIGS. 9A and 9B are flowcharts of a second embodiment of a management procedure executed by at least one mobile device of a management system of the present invention for controlling at least one target device.

### DETAILED DESCRIPTION OF TILE INVENTION

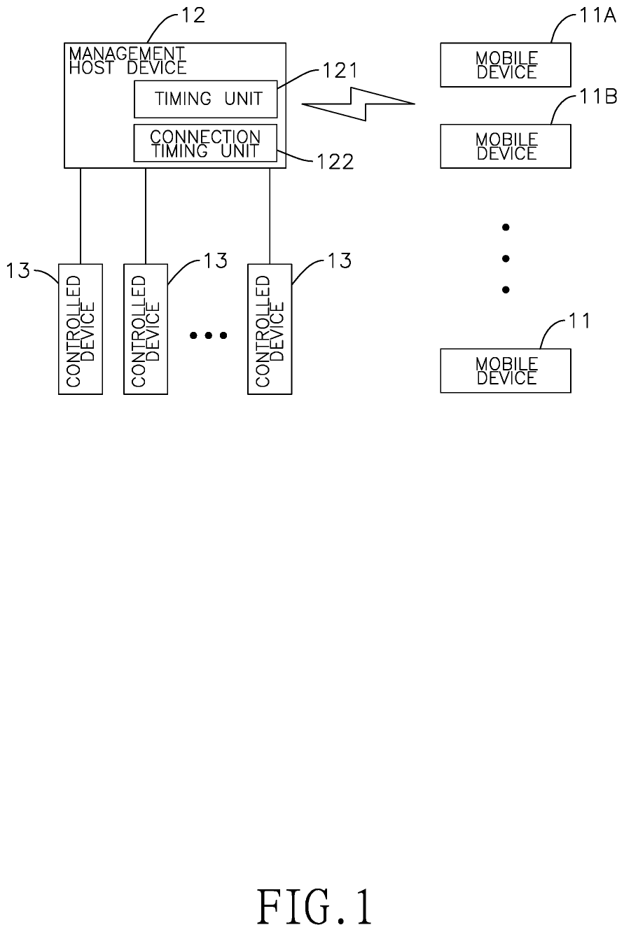

With reference to FIG. 1, the present invention relates to a management system and a management method for managing at least one target device. The management system includes at least one mobile device 11 and a management host device 12. The management host device 12 controls the at least one target device 13 to be turned on or off. In an embodiment of the present invention, the at least one mobile device 11 is wirelessly connected to the management host device 12. For example, the at least one mobile device 11 is connected to the management host device 12 through Bluetooth, Bluetooth Low Energy, or WiFi. The management host device 12 is connected to the at least one target device 13 through wired or wireless connection. Further, the management host device 12 includes a timing unit 121.

The management host device 12 executes a normal mode. When the management host device 12 executes the normal mode, the management host device 12 resets time of the timing unit 121, turns on the timing unit 121 to start timing, and broadcasts a first connection signal. The first connection signal includes a first connection tag. The management host device 12 further determines whether the time of the timing unit 121 exceeds a first preset time period. In the embodiment, the first connection signal broadcasted by the management host device 12 is received by the at least one mobile device 11, and steps executed by the at least one mobile device 11 are described in detail as follows.

When the management host device 12 executes the normal mode, and when the management host device 12 determines that the time of the timing unit 121 exceeds the first preset time period, the management host device 12 executes a temporary mode instead.

When the management host device 12 executes the temporary mode, the management host device 12 resets the time of the timing unit 121, turns on the timing unit 121 to start timing, stops broadcasting the first connection signal, and broadcasts a second connection signal instead. The second connection signal includes a second connection tag. The management host device 12 further determines whether a resume command transmitted by the at least one mobile device 11 is received. When the management host device 12 executes the temporary mode, and when the management host device receives 12 the resume command, the management host device 12 executes the normal mode instead.

When the management host device 12 executes the temporary mode, and when the management host device 12 does not receive the resume command, the management host device 12 determines whether the time of the timing unit 121 exceeds a second preset time period.

When the management host device 12 executes the temporary mode, and when the management host device 12 determines that the time of the timing unit 121 does not exceed the second preset time period, the management host device 12 broadcasts again the second connection signal, and determines again whether the resume command is received.

When the management host device 12 executes the temporary mode, and when the management host device 12 determines that the time of the timing unit 121 exceeds the second preset time period, the management host device 12 executes an unmanned mode instead.

When the management host device 12 executes the normal mode, the management host device 12 generates at least one normal mode control signal to control a startup state of the at least one target device 13. When the management host device 12 executes the unmanned mode, the management host device 12 generates at least one unmanned mode control signal to change the startup state of the at least one target device 13.

The user can set a plurality of unmanned commands and the unmanned commands can be stored in the management host device 12. When the management host device 12 executes the unmanned mode, the management host device 12 can execute the unmanned commands to meet the user's needs.

When the management host device 12 executes the temporary mode or the unmanned mode, the management host device 12 determines whether or not to execute the normal mode by determining whether the resume command is received. Moreover, the management host device 12 determines whether to stop executing the normal mode to execute the temporary mode by determining whether the time of the timing unit 121 exceeds the first preset time period, and the management host device 12 further determines whether to stop executing the temporary mode to execute the unmanned mode by determining whether the time of the timing unit 121 exceeds the second preset time period.

Therefore, the management host device 12 can determine whether the user is in the vicinity of the management host device 12 by determining whether the resume command is received, and the management host device 12 can also determine which mode needs to be executed by determining whether the resume command is received. Then, the management host device 12 can automatically turn on or off the at least one target device 13 according to the mode currently executed by the management host device 12. In this way, unnecessary power waste can be avoided, safety concerns can be avoided, and the furniture can be prevented from being splashed with rain.

Further, when the management host device 12 executes the unmanned mode, the management host device 12 broadcasts a third connection signal and determines whether the resume command is received. The third connection signal includes a third connection tag.

When the management host device 12 executes the unmanned mode, and when the management host device 12 receives the resume command, the management host device 12 executes the normal mode instead.

For example, the management host device 12 may be a desktop computer or a smart electronic device that is mounted at home or in an office, or the management host device 12 may be a control module that is mounted in an electrical appliance or in a switch of the electrical appliance. The at least one mobile device 11 may be a smart phone, a wearable device, a pet collar, or a smart device which can be easily carried by the user. The at least one target device 13 can be a variety of electrical appliances, such as a television, a computer, an electric fan, an air conditioner, an electric light, a water heater, a refrigerator, a host of a security system, or a window controller.

The at least one mobile device 11 is held by at least one user and can move along with the user. Therefore, when the management host device 12 can connect with the at least one mobile device 11 to receive the resume command, it represents the at least one user is at home or in the office. So the management host device 12 will execute the normal mode or the temporary mode to control the at least one target device 13. For example, when the at least one user is at home or in the office, the management host device 12 executes the normal mode or the temporary mode to control the at least one target device 13, such as to turn on a television, an air conditioner, a computer, an electric light, and a water heater. Therefore, the user may directly use the at least one target device 13 without manually turning on the at least one target device 13. On the other hand, the management host device 12 can control the security system to be turned off in the normal mode or the temporary mode to reduce power consumption. Alternatively, the management host device 12 can control a window controller to open the window for maintaining ventilation in the normal mode or the temporary mode.

Conversely, when the management host device 12 cannot receive the resume command, it represents that the user has left home or the office. Therefore, the management host device 12 will execute the unmanned mode instead to control the at least one target device 13. In the unmanned mode, the management host device 12 can control the at least one target device 13 to be turned on or off. For example, the management host device 12 can turn off the television, the air conditioner, the computer, the electric light, and the water heater to reduce power consumption. Further, when the management host device 12 executes the unmanned mode, the management host device 12 can control the security system to be turned on to perform home and office security monitoring. Moreover, when the management host device 12 executes the unmanned mode, the management host device 12 can control the window controller to close the window to prevent rain from splashing on the furniture. In this way, the user can leave home or the office without worries, and the at least one target device 13 at home or in the office can be controlled by the management host device 12, thereby reducing power consumption and automatically starting the security system. Unwanted power waste or safety concerns can be avoided.

In addition, when the management host device 12 executes the unmanned mode and receives the resume command to execute the normal mode instead, the management host device 12 further receives a remote control command transmitted by the at least one mobile device 11. The at least one normal mode control signal generated by the management host device 12 executing the normal mode is set according to the remote control command transmitted by the at least one mobile device 11.

Therefore, the user can set the remote control command by operating the at least one mobile device 11. When the user returns home, the management host device 12 stops executing the unmanned mode to execute the normal mode, and the management host device 12 can control the at least one target device 13 to be turned on or off according to the remote control command set by the user. Namely, the user can have personalized settings of the home environment.

Further, when the management host device 12 executes the normal mode and when the timing of the timing unit 121 does not exceed the first preset time period, the management host device 12 broadcasts again the first connection signal and determines again whether the tuning of the timing unit 121 exceeds the first preset time period.

The at least one mobile device 11 executes a management procedure. In the embodiment, the resume command is generated by the at least one mobile device 11 and transmitted to the management host device 12. When the at least one mobile device 11 executes the management procedure, the at least one mobile device 11 determines whether the second connection signal broadcasted by the management host device 12 is received. When the at least one mobile device 11 determines that the second connection signal broadcasted by the management host device 12 is received, the at least one mobile device 11 broadcasts a request command to establish a connection to the management host device 12. When the at least one mobile device 11 is connected with the management host device 12, the at least one mobile device 11 transmits the resume command to the management host device 12, and the at least one mobile device 11 ends the connection to the management host device 12. However, when the at least one mobile device 11 receives the first connection signal broadcasted by the management host device 12, the at least one mobile device 11 does not need to transmit any command to the management host device 12.

Namely, when the management host device 12 executes the normal mode, the management host device 12 repeatedly broadcasts the first connection signal during the first preset time period. When the at least one mobile device 11 receives the first connection signal broadcasted by the management host device 12, the at least one mobile device 11 does not automatically connect to the management host device 12, unless the user actively operates the at least one mobile device 11 to perform the connection to the management host device 12. Thereby, power consumption of the at least one mobile device 11 can be reduced.

However, when the at least one mobile device 11 receives the second connection signal broadcasted by the management host device 12 executing the temporary mode, the at least one mobile device 11 broadcasts the request command to establish the connection to the management host device 12, and then the at least one mobile device 11 transmits the resume command to the management host device 12. The at least one mobile device 11 ends the connection to the management host device 12, after the mobile device 11 transmits the resume command. Thereby, the power consumption of the mobile device 11 can be further reduced.

In addition, when the at least one mobile device 11 does not receive the second connection signal broadcasted by the management host 11 executing the temporary mode, the at least one mobile device 11 further determines whether the third connection signal broadcasted by the management host device 12 executing the unmanned mode is received. When the at least one mobile device 11 receives the third connection signal, the at least one mobile device 11 broadcasts the request command to establish a connection to the management host device 12. When the at least one mobile device 11 is successfully connected to the management host device 12, the at least one mobile device 11 transmits the resume command to the management host device 12. When the at least one mobile device 11 transmits the resume command to the management host device 12, the at least one mobile device 11 further transmits the remote control command to the management host device 12. The at least one mobile device 11 ends the connection to the management host 12, after the at least one mobile device 11 transmits the remote control command. Thereby the power consumption of the at least one mobile device 11 can be further reduced.

Since the management host device 12 executes the temporary mode before executing the unmanned mode, the at least one mobile device 11 does not need to continuously connect to the management host device 12. The management host device 12 only needs to receive the resume command transmitted by the at least one mobile device 11 during the second preset time period, and the management host device 12 can avoid executing the unmanned mode.

When the management host device 12 executes the temporary mode and broadcasts the second connection signal to the at least one mobile device 11, the at least one mobile device 11 broadcasts the request command to establish the connection to the management host device 12. Then, the at least one mobile device 11 transmits the resume command to the management host device 12 to make the management host device 12 execute the normal mode instead. In this way, the at least one mobile device 11 does not need to be connected to the management host device 12 for a long time, and thus the power consumption of the at least one mobile device 11 can be reduced.

In addition, the at least one mobile device 11 communicates with the management host device 12 through wireless transmission. When there are many target devices 13 in an environment, and if the at least one mobile device 11 continually connects to the management host 12 for a long time, these represent there are many handshake signals in the environment. Therefore, the handshake signals may mutually interfere with each other, transmission efficiency may be decreased, and the handshake signals even result in failure of connection. Since the handshake signals even result in the failure of the connection, signals for communication between the at least one mobile device 11 and the management host device 12 may be repeatedly transmitted. These may increase the power consumption of the at least one mobile device 11, and thereby a frequency of replacing or charging a battery of the at least one mobile device 11 may be also increased.

If wireless signals in a wireless channel are not overcrowded, the number of the at least one mobile device 11 and the at least one target device 13 in the same area may be increased, and the wireless signals may not mutually interfere with each other. Therefore, the at least one mobile device 11 of the present invention does not need to be connected to the management host device 12 for a long time to decrease the wireless signals of wireless communication. The effect of the present invention not only can reduce the power consumption of the at least one mobile device 11, but also can increase the number of the at least one mobile device 11 and the at least one target device 13 in the same area.

Further, when the management host device 12 executes the unmanned mode, the management host device 12 broadcasts the third connection signal instead, and the management host device 12 determines whether the resume command transmitted by the at least one mobile device 11 is received. When the management host device 12 executes the unmanned mode and when the management host device 12 does not receive the resume command transmitted by the at least one mobile device 11, the management host device 12 broadcasts again the third connection signal, and the management host device 12 determines again whether the resume command is received. When the management host device 12 receives the resume command, the management host device 12 executes the normal mode instead.

Moreover, in another embodiment, the second connection signal broadcasted by the management host device 12 executing the temporary mode is the same as the third connection signal broadcasted by the management host device 12 executing the unmanned mode. When the management host device 12 executes the unmanned mode and when the management host device 12 receives the resume command, the management host device 12 executes the normal mode instead, and then the management host device 12 transmits a reset signal to the mobile device 11.

When the at least one mobile device 11 executes the management procedure, the at least one mobile device 11 determines whether the second connection signal broadcasted by the management host device 12 is received. When the at least one mobile device 11 determines that the second connection signal is received, the at least one mobile device 11 broadcasts the request command to establish the connection to the management host device 12. When the at least one mobile device 11 is successfully connected with the management host device 12, the at least one mobile device 11 further determines whether the reset signal is received. When the at least one mobile device 11 determines that the reset signal is received, the at least one mobile device 11 transmits the resume command to the management host device 12. Then, the at least one mobile device 11 further transmits the remote control command to the management host device 12, and the at least one mobile device 11 ends the connection to the management host 12. However, when the at least one mobile device 11 receives the first connection signal broadcasted by the management host device 12, the at least one mobile device 11 does not need to transmit any command to the management host device 12.

If the second connection signal is the same as the third connection signal, the at least one mobile device 11 will not know which mode is currently executed by the management host device 12 according to the connection signal broadcasted by the at least one mobile device 11. Namely, the at least one mobile device 11 cannot determine whether the management host device 12 executes the normal mode from the temporary mode, or whether the management host device 12 executes the nominal mode from the unmanned mode according to the connection signal broadcasted by the at least one mobile device 11.

Therefore, when the management host device 12 executes the unmanned mode and receives the resume command, the management host device 12 executes the normal mode instead. At this time, when the management host device 12 executes the normal mode from the unmanned mode, the management host device 12 will further transmit the reset signal to notify the at least one mobile device 11. Thus, the at least one mobile device 11 can determine that the management host device 12 executes the normal mode from the unmanned mode or from the temporary mode.

For example, when the at least one mobile device 11 receives the reset signal, it represents that the management host device 12 executes the normal mode from the unmanned mode. When the management host device 12 executes the normal mode from the unmanned mode, the management host device 12 will receive the remote control command transmitted by the at least one mobile device 11. When the at least one mobile device 11 does not receive the reset signal, it means that the management host device 12 executes the normal mode from the temporary mode, and the management host device 12 no need to receive the remote control command transmitted by the at least one mobile device 11.

The management system may include one or more mobile devices 11, and each mobile device 11 can have different settings. Namely, the mobile devices 11 can respectively control the at least one target device 13 according to whether the reset signal is received. In other words, when the management host device 12 executes the unmanned mode, the management host device 12 can automatically control the at least one target device 13 to be turned on or off. When the management host device 12 executes the normal mode from the unmanned mode, the mobile device 11 can control the at least one target device 13 to be turned on or off through the management host device 12. Therefore, each mobile device 11 can be individually set to meet each user's need.

For example, the management host device 12 manages a first electric light and a second electric light, and the management host device 12 registers two mobile devices 11A, 11B. The mobile device 11A is set to turn on the first electric light when the mobile device 11A receives the reset signal. The mobile device 11B is set to turn on the second electric light when the mobile device 11B receives the reset signal. Therefore, the mobile devices 11 can respectively have different settings to respectively control the at least one target device 13 when the mobile devices receive the reset signal. The user can freely adjust the setting of the mobile devices 11 to achieve the user's most suitable settings. Further, since these settings are stored in the mobile devices 11, the management host device 12 does not need to store the settings, thereby simplifying design of the management host device 12 and lowering requirement of memory capacity of the management host device 12.

In another embodiment, the user can set the reset command and store the reset command in the management host device 12. When the management host device 12 executes the unmanned mode and receives the resume command, the management host device 12 executes the normal mode instead. At this time, the management host device 12 can control the at least one target device 13 according to the reset command stored in the management host device 12. In this way, the mobile device 11 does not need to communicate with the management host device 12, and connection time for connecting the management host device 12 with the at least one mobile device 11 can be decreased. Thereby, the consumed power of the at least one mobile device 11 can be also decreased.

Further, the sum of the first preset time period and the second preset time period represents total time for the management host device 12 to execute the unmanned mode from the nom al mode. The first preset time period and the second preset time period can be set by the user according to different usage scenarios. For example, if the user needs to frequently enter and leave a work area, a short predetermined time may cause the management host device 12 unexpectedly to execute the unmanned mode, which may cause troubles in use. However, when the at least one target device 13 controlled by the management host device 12 is an LED, the first preset time period and the second preset time period can be shortened to achieve a better power saving effect. Therefore, it is up to the user to set the appropriate time to meet the use demand.

Moreover, the at least one mobile device 11 determines whether a startup command is generated before the at least one mobile device 11 determines whether the second connection signal is received. When the at least one mobile device 11 determines that the startup command is generated, the at least one mobile device 11 determines whether the second connection signal is received. However, when the at least one mobile device 11 determines that the startup command is not generated, the at least one mobile device 11 determines again whether the startup command is generated.

The at least one mobile device 11 can be set by the user to determine whether to generate the startup command. When the startup command is generated by the at least one mobile device 11, the at least one mobile device 11 can connect with the management host device 12 and transmit the resume command to the management host device 12.

For example, the at least one mobile device 11 can be a tablet computer. The user installs an application program in the tablet computer to execute the management procedure. However, the user may not carry the tablet computer with him. When the user wants to go out, the user can set the tablet computer to end the application program, and the tablet computer stops generating the startup command. Then, the tablet computer may not continuously transmit the resume command Thereby, when the user goes out, the tablet computer may not transmit the resume command, and the management host device 12 may not continuously receive the resume command. The management host device 12 may execute the unmanned mode after the user goes out without carrying the tablet computer.

In addition, in one embodiment, the management host device 12 executes a connection procedure to establish a connection to the at least one mobile device 11. The management host device 12 establishes the connection to and the at least one mobile device 11 through a handshake protocol.

In order to resist a malicious attack, if someone wants to invade the management host device 12 to shut down the security system, the management host device 12 needs to establish a secure connection to the at least one mobile device 11. Only the resume command transmitted under the secure connection can be accepted by the management host device 12.

In one embodiment, the at least one mobile device 11 is connected with the management host device 12 through the Bluetooth Low Energy technology as a transmission protocol. The management host device 12 should execute a host registration procedure to register the at least one mobile device 11 before the management host device 12 executes the normal mode.

For example, when the management host device 12 executes the connection procedure, the management host device 12 determines whether the host registration procedure needs to be executed at first. When the management host device 12 determines that the host registration procedure needs to be executed, the management host device 12 executes the host registration procedure to establish the connection to the at least one mobile device 11, and to register identity information of the at least one mobile device 11 in the management host device 12. When the management host device 12 determines that the host registration procedure does not need to be executed, the management host device 12 monitors the request command broadcasted by the at least one mobile device 11, and the management host device 12 determines whether the request command broadcast by the at least one mobile device 11 is received.

When the management host device 12 receives the request command broadcasted by the at least one mobile device 11, the management host device 12 further determines whether the request command broadcasted by the at least one mobile device 11 is authenticated according to the identity information of the at least one mobile device 11 registered in the management host device 12.

When the management host device 12 does not receive the request command broadcasted by the at least one mobile device 11, the management host device 12 monitors again the request command broadcasted by the at least one mobile device 11. Further, when the management host device 12 determines that the request command broadcasted by the at least one mobile device 11 is not authenticated, the management host device 12 monitors again the request command broadcasted by the at least one mobile device 11.

When the management host device 12 determines that the request command broadcasted by the at least one mobile device 11 has been authenticated, the management host device 12 establishes the connection to the at least one mobile device 11, and the management host device 12 turns on a connection timing unit 122 of the management host device 12 to start timing.

The management host device 12 further receives the resume command transmitted by the at least one mobile device 11, and the management host device 12 determines whether time of the connection timing unit 122 exceeds a third preset time period. When the management host device 12 determines that the time of the connection timing unit 122 exceeds the third preset time period, the management host device 12 ends the connection to the at least one mobile device 11, and the management host device 12 resets the time of the connection timing unit 122. Then, the management host device 12 monitors again the request command broadcasted by the at least one mobile device 11 to determine whether the request command is received.

When the management host device 12 determines that the time of the connection timing unit 122 does not exceed the third preset time period, the management host device 12 receives again the resume command transmitted by the mobile device 11.

For example, the request command broadcasted by the at least one mobile device 11 includes the identity information of the at least one mobile device 11. The management host device 12 executes the registration procedure to register the at least one mobile device 11, and establishes a white list. When the management host device 12 receives the request command broadcasted by the at least one mobile device 11, the management host device 12 can authenticate the at least one mobile device 11 according to the request command. Namely, the management host device 12 can confirm that whether the identity information of the at least one mobile device 11 is included on the white list, that is, whether the at least one mobile device 11 is already registered. After that, when the management host device 12 determines that the identity information of the at least one mobile device 11 is included on the white list, the management host device 12 will execute subsequent processes with the mobile device.

Then, when the management host device 12 receives the request command broadcasted by the at least one mobile device 11, the management host device 12 can authenticate the request command by comparing the identity information included in the request command and the identity information registered in the management host device 12. Thereby, the management host device 12 can confirm whether the received request command is broadcasted by the registered mobile device 11.

As a result, the management host device 12 can avoid misjudgment. The management host device 12 can determine that the at least one mobile device 11 that broadcasts the request command is registered, and the management host device 12 can determine that the at least one mobile device 11 near the management host device 12 is the registered mobile device 11, not any unregistered mobile device.

In addition, in another embodiment of the present invention, the at least one mobile device 11 determines whether a device registration procedure needs to be executed at first. When the at least one mobile device 11 determines that the device registration procedure needs to be executed, the at least one mobile device 11 executes the device registration procedure to establish a connection to the management host device 12, and to register identity information of the management host device 12 in the at least one mobile device 11.

When the at least one mobile device 11 determines that the device registration procedure does not need to be executed, the at least one mobile device 11 executes a management procedure to determine whether the startup command is generated. When the at least one mobile device 11 generates the startup command, the at least one mobile device 11 determines whether the second connection signal broadcasted by the management host device 12 is received. When the at least one mobile device 11 receives the second connection signal broadcasted by the management host device 12, the at least one mobile device 11 determines whether the second connection signal is authenticated by comparing the identity information included in the second connection signal and the identity information registered in the at least one mobile device 11.

When the at least one mobile device 11 determines that the second connection signal has been authenticated, the at least one mobile device 11 further determines whether an environmental condition is met according to environment information.

When the at least one mobile device 11 determines that the environment information meets the environmental condition, the at least one mobile device 11 transmits the request command to establish the connection to the management host device 12. Then, the at least one mobile device 11 transmits the resume command to the management host device 12 after the connection to the management host device 12 is established.

For example, the environment information is signal strength of the second connection signal. The at least one mobile device 11 can calculate a distance to the management host device 12 according to the strength of the second connection signal transmitted by the management host device 12. When the at least one mobile device 11 determines that the signal strength of the second connection signal is greater than a threshold value, the at least one mobile device 11 determines that the environment information meets the environmental condition. Then, the at least one mobile device 11 transmits the request command to the management host device 12 to establish the connection to the management host device 12.

For another example, the at least one target device 13 is an electric light in a house. The management host device 12 can control the electric light. The at least one mobile device 11 is a smart phone. When the user carries the at least one mobile device 11 and stay in the house, the at least one mobile device 11 can sense an ambient brightness in the house, and the at least one mobile device 11 generates the environment information according to the ambient brightness. When the at least one mobile device 11 determines that the ambient brightness is greater than a brightness threshold value, the at least one mobile device 11 determines that the environment information does not meet the environmental condition. That represents that the ambient brightness in the house is bright enough. Therefore, the at least one mobile device 11 dose not transmit the request command to establish the connection to the management host device 12. The management host device 12 does not execute the normal mode, and the management host device 12 does not control the electric light to be turned on.

For further example, the target device 13 is a window controller in the house. The management host 12 controls the window controller to open or close windows in the house. The at least one mobile device 11 is a smart phone, and the at least one mobile device 11 can be connected to the Internet to determine current weather information. The current weather information can be used as the environment information. When the at least one mobile device 11 determines from the current weather information that the weather is rainy, the at least one mobile device 11 determines that the environment information does not meet the environmental condition. Therefore, when the user returns to the house, the at least one mobile device 11 does not transmit the request command to establish the connection to the management host device 12. Then, the management host device 12 does not execute the normal mode, and the management host device 12 does not control the window to be opened to prevent the rainwater from splashing into an interior of the house.

In addition, the at least one mobile device 11 determines whether the environment information meets the environmental condition, before the at least one mobile device 11 is connected to the management host device 12. When the at least one mobile device 11 determines that the environment information does not meet the environmental condition, the at least one mobile device 11 does not connect with the management host device 12.

Therefore, the at least one mobile device 11 can reduce a number of times of connection to the management host device 12, and the power consumption of the at least one mobile device 11 can be reduced. Further, the wireless signals of the devices do not frequently mutually interfere with each other.

In addition, this environmental condition can be set by the user to meet the user's needs. For example, the environment information is the signal strength of the received second connection signal broadcasted by the management host device 12. The user can set the threshold value of the signal strength as the environmental condition. For another example, when the management host device 12 controls the electric light in the house, the user can set the ambient brightness in the house as the environment information, and can set the brightness threshold value as the environmental condition. Then, the user can decide whether to enter the unmanned mode to turn off the electric light according to the ambient brightness.

The first connection signal, the second connection signal, and the third connection signal are used to indicate the current mode executed by the management host device 12. However, this also reveals information that there is no one at home. For example, when the management host device 12 continuously broadcasts the third connection signal, any user of the at least one mobile device 11 receiving the third connection signal can know that the management host device 12 executes the unmanned mode. The management host device 12 executing the unmanned mode can represent that there is no one at home. To avoid this situation, the first connection tag in the first connection signal, the second connection tag in the second connection signal, and the third connection tag in the third connection signal should be encrypted.

In one embodiment, when the at least one mobile device 11 registers with the management host device 12, a private key generated by the management host device 12 is stored in the at least one mobile device 11. Then, the management host device 12 encrypts the first connection tag, the second connection tag, and the third connection tag, and the management host device 12 transmits the first connection signal, the second connection signal, and the third connection signal which each respectively include a public key. The management host device 12 further continuously updates the public key and encrypts the first connection tag, the second connection tag, and the third connection tag. As a result, only the registered mobile device 11 can decrypt the first connection tag, the second connection tag, and the third connection tag. The registered mobile device 11 can know the current mode executed by the management host device 12 to avoid revealing whether there is a person in the house or not.

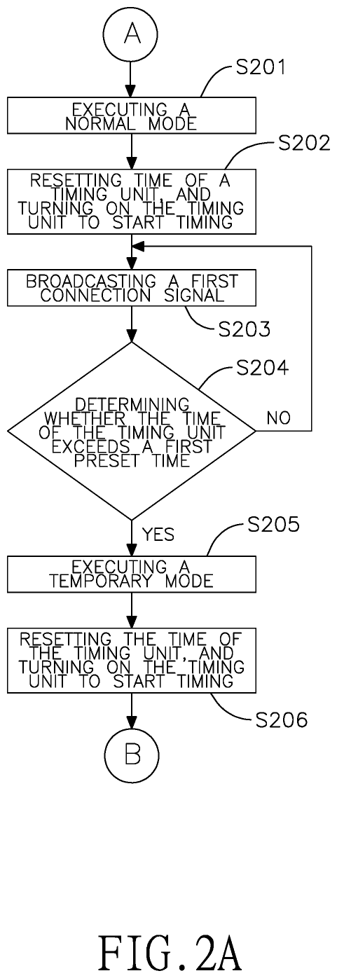

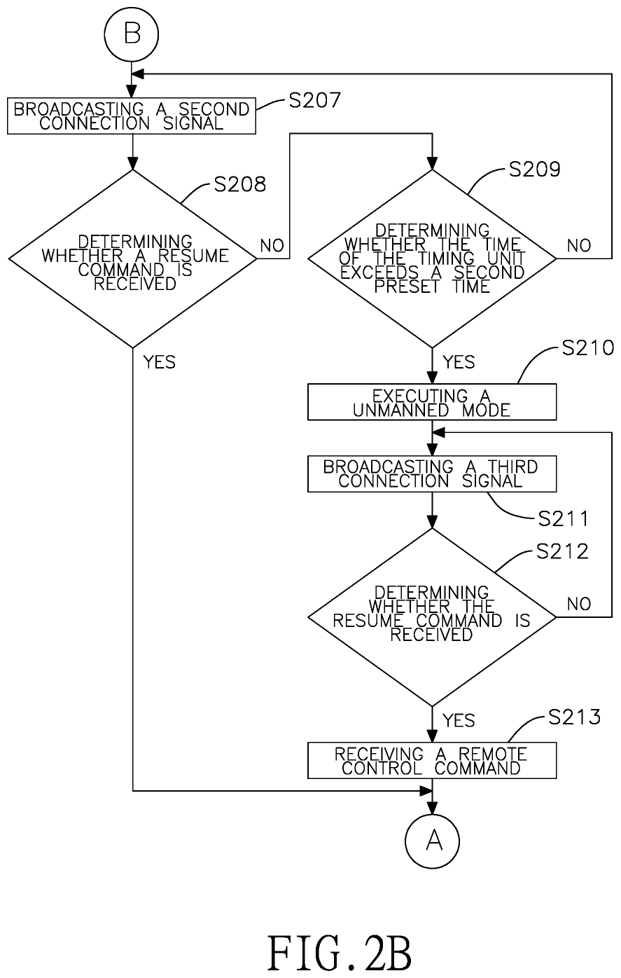

With reference to FIGS. 2A and 2B, a management method for controlling the at least one target device may be determined according to the above content. The management method is executed by the management host device. A first embodiment of the management method includes the following steps:

executing a normal mode (S201);

in the normal mode, resetting time of a timing unit, and turning on the timing unit to start timing (S202);

broadcasting a first connection signal (S203); wherein the first connection signal includes a first connection tag;

determining whether the time of the timing unit exceeds a first preset time period (S204);

when the time of the timing unit exceeds the first preset time period, executing a temporary mode instead (S205);

in the temporary mode, resetting the time of the timing unit, and turning on the timing unit to start timing (S206);

in the temporary mode, stopping broadcasting the first connection signal to broadcast a second connection signal (S207); wherein the second connection signal includes a second connection tag;

determining whether a resume command transmitted by at least one mobile device is received (S208); wherein

when the resume command is received, executing the normal mode instead (S201);

when the resume command is not received, determining whether the time of the timing unit exceeds a second preset time period (S209); wherein

when the time of the timing unit does not exceed the second preset time period, continuously broadcasting the second connection signal (S207), and determining again whether the resume command is received (S208);

when the time of the timing unit exceeds the second preset time period, executing an unmanned mode instead (S210).

In the first embodiment of the management method, when the management host device executes the normal mode, the management host device generates at least one normal mode control signal to control a startup state of the at least one target device. When the management host device executes the unmanned mode, the management host device generates at least one unmanned mode control signal to change the startup state of the at least one target device.

The management method further includes the following steps:

in the normal mode, when the time of the timing unit does not exceed the first preset time period, continuously broadcasting the first connection signal (S203), and determining again whether the time of the timing unit exceeds the first preset time period (S204);

in the unmanned mode, broadcasting a third connection signal (S211), and determining whether the resume command is received (S212); wherein

when the resume command is received, further receiving a remote control command (S213), and executing the normal mode instead (S201);

when the resume command is not received, continuously broadcasting the third connection signal (S211).

In the first embodiment of the management method, the remote control command is generated by the at least one mobile device, and is transmitted to the management host device.

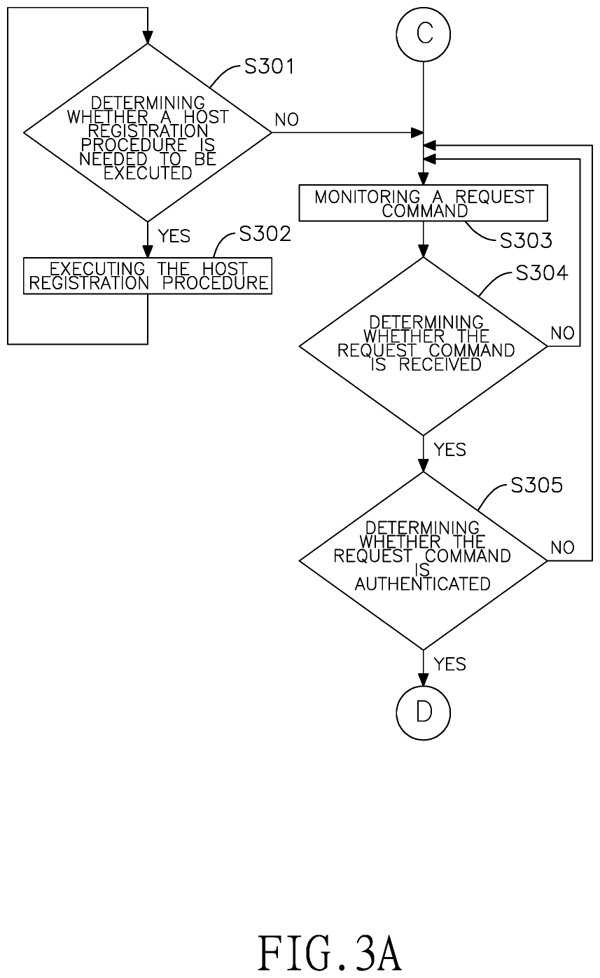

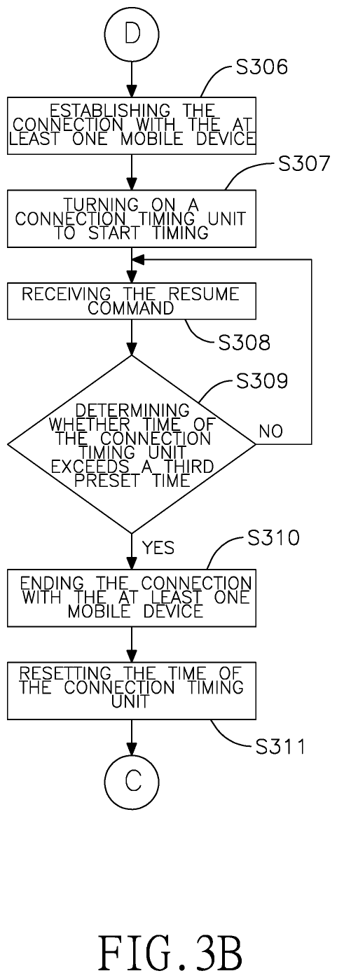

Further, with reference to FIGS. 3A and 3B, the management method further includes a connection procedure to establish a connection to the at least one mobile device. The connection between the management host device and the at least one mobile device is established through a handshake protocol. A first embodiment of the connection procedure includes the following steps:

determining whether a host registration procedure needs to be executed (S301);

when the host registration procedure needs to be executed, executing the host registration procedure (S302) to establish the connection to the at least one mobile device, and registering identity information of the at least one mobile device;

when the host registration procedure does not need to be executed, monitoring a request command broadcasted by the at least one mobile device (S303);

determining whether the request command broadcasted by the at least one mobile device is received (S304),

when the request command broadcasted by the at least one mobile device is received, determining whether the request command is authenticated according to the registered identity information of the at least one mobile device (S305);

when the request command has been authenticated, establishing the connection to the at least one mobile device (S306);

turning on a connection timing unit to start timing (S307);

receiving the resume command transmitted by the at least one mobile device (S308);

determining whether time of the connection timing unit exceeds a third preset time period (S309); wherein

when the time of the connection timing unit exceeds the third preset time period, ending the connection to the at least one mobile device (S310), resetting the time of the connection timing unit (S311), and monitoring again the request command broadcasted by the at least one mobile device (S303) to determine whether the request command is received (S304);

when the time of the connection timing unit does not exceed the third preset time period, receiving again the resume command transmitted by the mobile device (S308);

when the request command is not received, monitoring again the request command broadcasted by the at least one mobile device (S303);

when the request command broadcasted by the at least one mobile device is not authenticated, monitoring again the request command broadcasted by the at least one mobile device (S303).

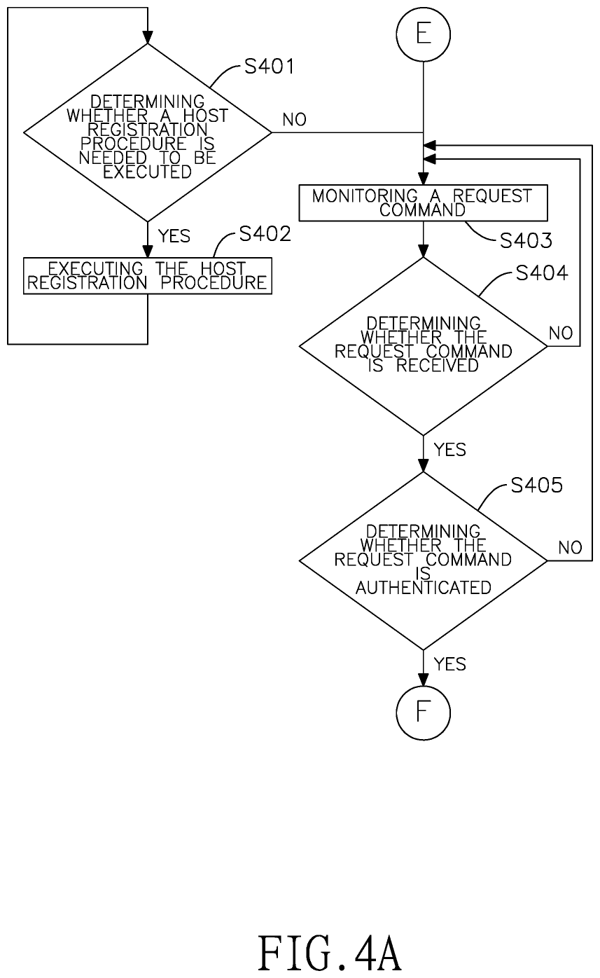

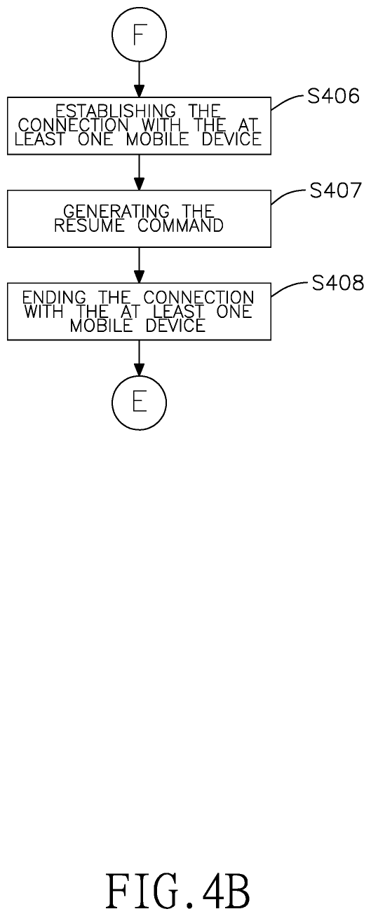

With reference to FIGS. 4A and 4B, a second embodiment of the connection procedure includes the following steps:

determining whether a host registration procedure needs to be executed (S401);

when the host registration procedure needs to be executed, executing the host registration procedure (S402) to establish the connection to the at least one mobile device, and registering identity information of the at least one mobile device;

when the host registration procedure does not need to be executed, monitoring a request command broadcasted by the at least one mobile device (S403), and determining whether the request command broadcasted by the at least one mobile de

vice is received (S404); when the request command broadcasted by the at least one mobile device is received, determining whether the request command is authenticated according to the registered identity information of the at least one mobile device (S405);

when the request command has been authenticated, establishing the connection to the at least one mobile device (S406), generating the resume command (S407), ending the connection to the at least one mobile device, and monitoring again the request command broadcasted by the at least one mobile device (S403) to determine whether the request command is received (S404);

when the request command is not received, monitoring again the request command broadcasted by the at least one mobile device (S403);

when the request command broadcasted by the at least one mobile device is not authenticated, monitoring again the request command broadcasted by the at least one mobile device (S403).

In the second embodiment of the connection procedure, the resume command is generated by the management host device. Therefore, when the management host device establishes the connection to the at least one mobile device, the management host device does not need to receive the resume command transmitted by the at least one mobile device. The management host device can directly stop executing the unmanned mode to execute the normal mode according to the resume command generated by the management host device. Therefore, the management host device can quickly execute the normal mode instead.

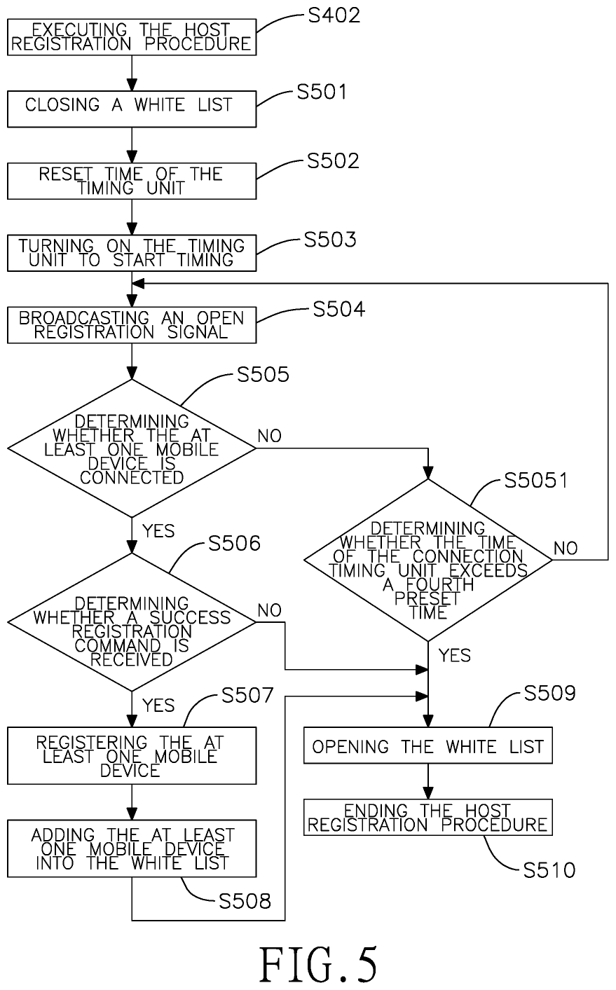

With reference to FIG. 5, the host registration procedure includes the following steps:

closing a white list (S501);

resetting time of the timing unit (S502);

turning on the timing unit to start timing (S503);

broadcasting an open registration signal (S504); wherein the open registration signal includes an open registration tag;

determining whether the at least one mobile device is connected (S505);

when the at least one mobile device is connected, determining whether a success registration command transmitted by the at least one mobile device is received (S506);

when the success registration command transmitted by the at least one mobile device is received, registering the at least one mobile device (S507), adding the at least one mobile device to the white list (S508), opening the white list, and ending the host registration procedure (S510);

when there is no connected mobile device, determining whether the time of the connection timing unit exceeds a fourth preset time period (S5051);

when the time of the connection timing unit exceeds the fourth preset time period, opening the white list (S509), and ending the host registration procedure (S510);

when the time of the connection timing unit does not exceed the fourth preset time period, continuously broadcasting the open registration signal (S504),

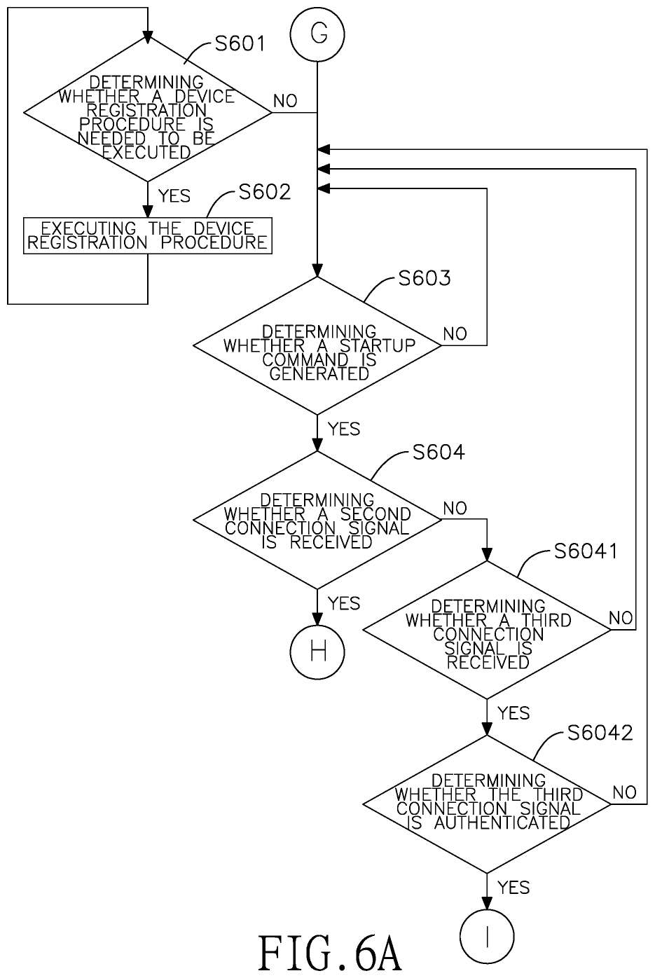

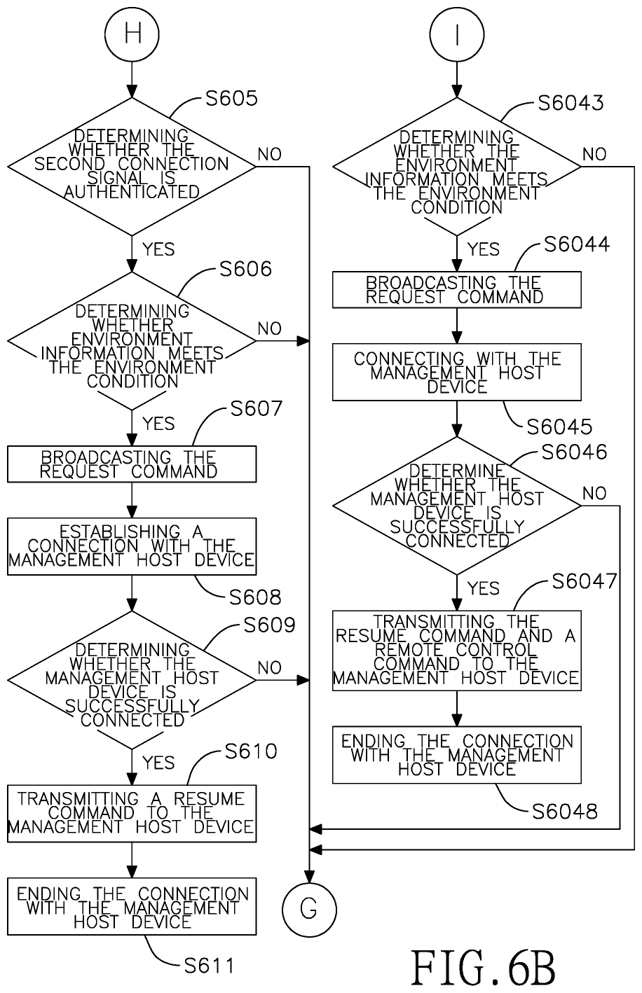

With reference to FIGS. 6A and 6B, a first embodiment of the management procedure executed by the at least one mobile device includes the following steps:

determining whether a device registration procedure needs to be executed (S601);

when the device registration procedure needs to be executed, executing the device registration procedure (S602) to establish the connection to the management host device, and registering identity information of the management host device;

when the host registration procedure does not need to be executed, determining whether a startup command is generated (S603);

when the startup command is generated, determining whether a second connection signal broadcasted by the management host device is received (S604);

when the second connection signal is received, determining whether the second connection signal is authenticated according to the registered identity information of the management host device (S605);

when the second connection signal has been authenticated, determining whether environment information meets the environmental condition (S606);

when the environment information meets the environmental condition, broadcasting the request command (S607), establishing a connection to the management host device (S608), and determining whether the management host device is successfully connected (S609);

when the management host device is successfully connected, transmitting a resume command to the management host device (S610), and ending the connection to the management host device (S611);

when the management host device is not successfully connected, determining again whether the startup command is generated (S603);

when the startup command is not generated, determining again whether the startup command is generated (S603);

when the second connection signal is not authenticated, determining again whether the startup command is generated (S603);

when the environment information does not meet the environmental condition, determining again whether the startup command is generated (S603);

when the second connection signal is not received, determining whether a third connection signal is received (S6041);

when the third connection signal is received, determining whether the third connection signal is authenticated according to the registered identity information of the management host device (S6042);

when the third connection signal has been authenticated, determining whether the environment information meets the environmental condition (S6043);

when the environment information meets the environmental condition, broadcasting the request command (S6044), connecting with the management host device (S6045), and determining whether the management host device is successfully connected (S6046);

when the management host device is successfully connected, transmitting the resume command and a remote control command to the management host device (S6047), and ending the connection to the management host device (S6048);

when the management host device is not successfully connected, determining again whether the startup command is generated (S603);

when the third connection signal is not authenticated, determining again whether the startup command is generated (S603);

when the environment information does not meet the environmental condition, determining again whether the startup command is generated (S603);

when the management host device is not successfully connected, determining again whether the startup command is generated (S603).

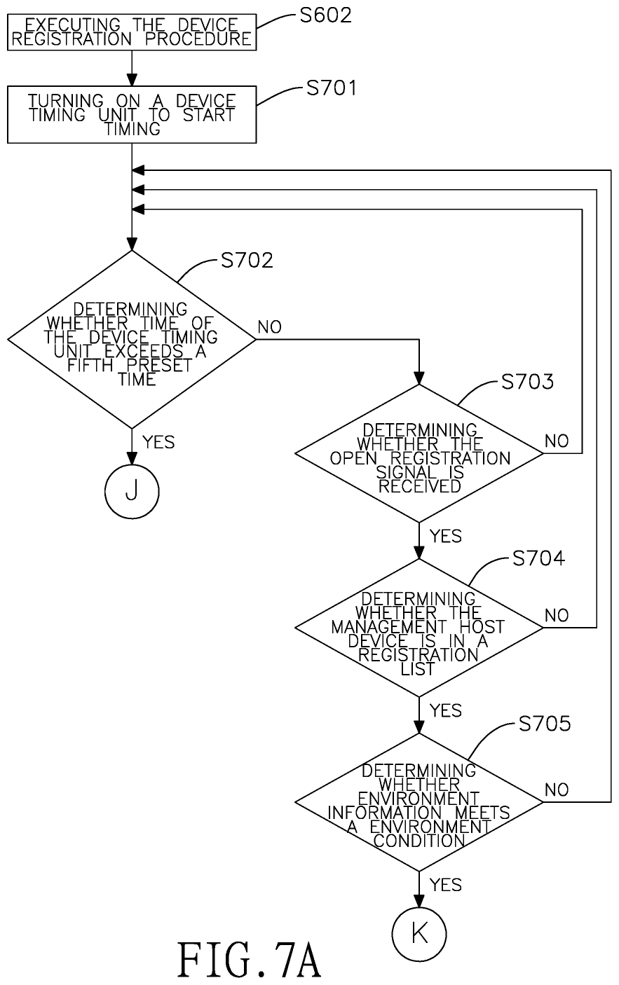

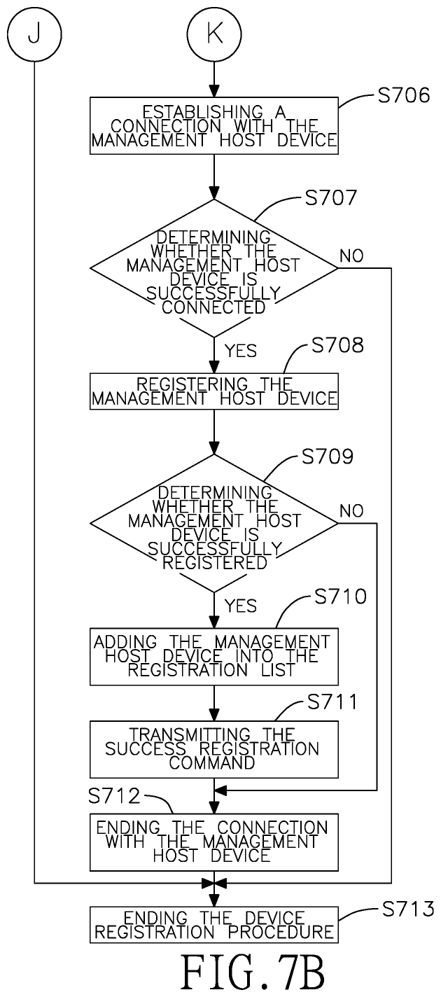

With reference to FIGS. 7A and 7B, the device registration procedure includes the following steps:

turning on a device timing unit to start timing (S701);

determining whether time of the device timing unit exceeds a fifth preset time period (S702);

when the time of the device timing unit does not exceed the fifth preset time period, determining whether the open registration signal broadcasted by the management host device is received (S703);

when the open registration signal broadcasted by the management host device is received, determining whether the management host device is in a registration list (S704);

when the management host device is not in the registration list, determining whether environment information meets an environmental condition (S705);

when the environment information meets the environmental condition, establishing a connection to the management host device (S706), and determining whether the management host device is successfully connected (S707);

when the management host device is successfully connected, registering the management host device (S708), and determining whether the management host device is successfully registered (S709);

when the management host device is successfully registered, adding the management host device into the registration list (S710), transmitting the success registration command (S711), ending the connection to the management host device (S712), and ending the device registration procedure (S713);

when the time of the device timing unit exceeds the fifth preset time period, ending the device registration procedure (S713);

when the open registration signal broadcasted by the management host device is not received, determining again whether the time of the device timing unit exceeds the fifth preset time period (S702);

when the management host device is in the registration list, determining again whether the time of the device timing unit exceeds the fifth preset time period (S702);

when the environment information does not meet the environmental condition, determining again whether the time of the device timing unit exceeds the fifth preset time period (S702);

when the management host device is not successfully connected, ending the device registration procedure (S713);

when the management host device is not successfully registered, ending the connection to the management host device (S712), and ending the device registration procedure (S713).

In a second embodiment of the management method for controlling the at least one target device, the second connection signal broadcasted by the management host device in executing the temporary mode is the same as the third connection signal broadcasted by the management host device in executing the unmanned mode. The following is an illustration of this embodiment.

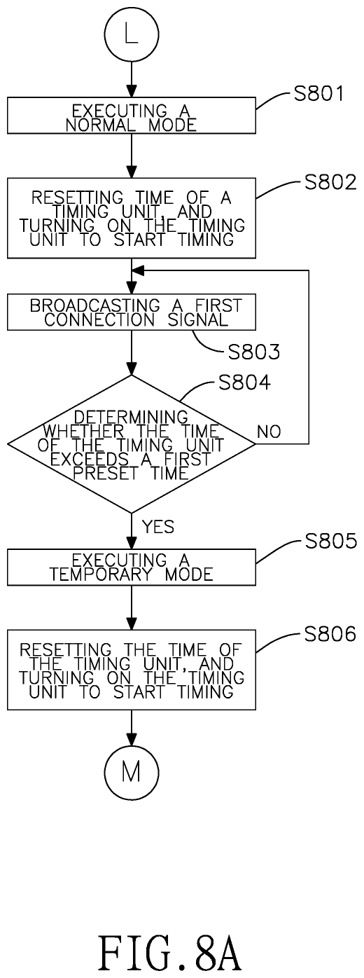

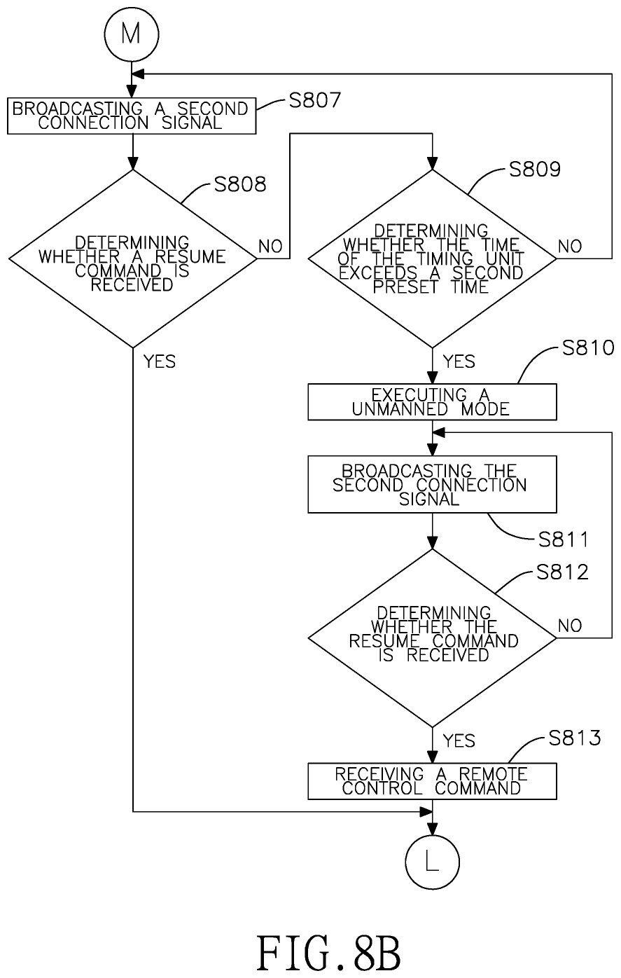

With reference to FIGS. 8A and 8B, the second embodiment of the management method for controlling the at least one target device includes the following steps:

executing a normal mode (S801);

in the normal mode, resetting time of a timing unit, and turning on the timing unit to start timing (S802);

broadcasting a first connection signal (S803); wherein the first connection signal includes a first connection tag;

determining whether the time of the timing unit exceeds a first preset time period (S804);

when the time of the timing unit exceeds the first preset time period, executing a temporary mode instead (S805);

in the temporary mode, resetting the time of the timing unit, and turning on the timing unit to start timing (S806);

in the temporary mode, stopping broadcasting the first connection signal, and broadcasting a second connection signal instead (S807); wherein the second connection signal includes a second connection tag;

determining whether a resume command transmitted by a mobile device is received (S808); wherein

when the resume command is received, executing the normal mode instead (S801);

when the resume command is not received, determining whether the time of the timing unit exceeds a second preset time period (S809); wherein

when the time of the timing unit does not exceed the second preset time period, continuously broadcasting the second connection signal (S807), and determining again whether the resume command is received (S808);

when the time of the timing unit exceeds the second preset time period, executing an unmanned mode instead (S810);

in the nominal mode, when the time of the timing unit does not exceed the first preset time period, continuously broadcasting the first connection signal (S803), and determining again whether the time of the timing unit exceeds the first preset time period (S804);

in the unmanned mode, broadcasting the second connection signal (S811), and determining whether the resume command is received (S812); wherein

when the resume command is received, transmitting a reset signal to the at least one mobile device, receiving a remote control command (S813), and executing the normal mode instead (S801);

when the resume command is not received, continuously broadcasting the second connection signal (S811).

In the second embodiment of the management method, the resume command and the remote control command are generated by the at least one mobile device, and the at least one mobile device transmits the resume command and the remote control command to the management host device.

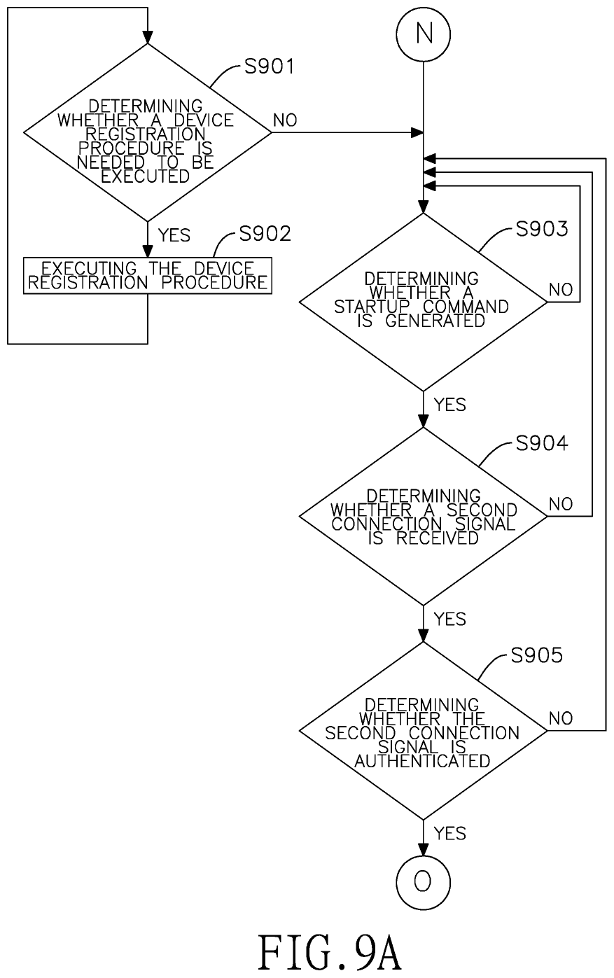

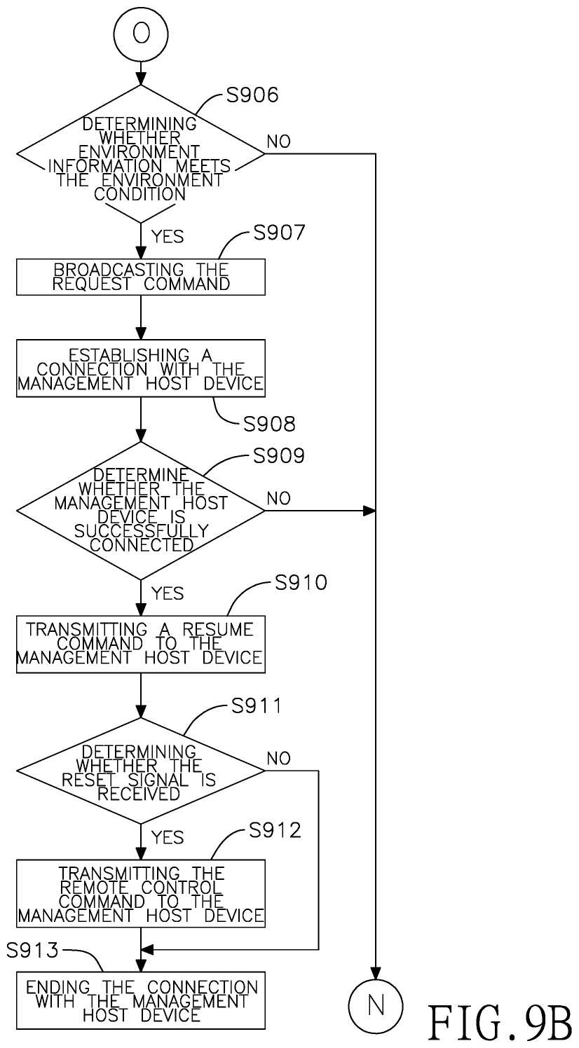

In addition, a second embodiment of the management procedure executed by the at least one mobile device is implemented corresponding to the second embodiment of the management method for controlling the at least one target device. With reference to FIGS. 9A and 9B, the second embodiment of the management procedure executed by the at least one mobile device includes the following steps:

determining whether a device registration procedure needs to be executed (S901);

when the device registration procedure needs to be executed, executing the device registration procedure (S902) to establish the connection to the management host device, and registering identity information of the management host device;

when the host registration procedure does not need to be executed, determining whether a startup command is generated (S903);

when the startup command is generated, determining whether a second connection signal broadcasted by the management host device is received (S904);

when the second connection signal is received, determining whether the second connection signal is authenticated according to the registered identity information of the management host device (S905);

when the second connection signal has been authenticated, determining whether environment information meets the environmental condition (S906);

when the environment information meets the environmental condition, broadcasting the request command (S907), establishing a connection to the management host device (S908), and determining whether the management host device is successfully connected (S909);

when the management host device is successfully connected, transmitting a resume command to the management host device (S910), and determining whether the reset signal is received (S911);

when the reset signal is received, transmitting the remote control command to the management host device (S912), and ending the connection to the management host device (S913);

when the reset signal is not received, ending the connection to the management host device (S913);

when the startup command is not generated, determining again whether the startup command is generated (S903);

when the second connection signal is not received, determining again whether the startup command is generated (S903);

when the second connection signal is not authenticated, determining again whether the startup command is generated (S903);

when the environment information does not meet the environmental condition, determining again whether the startup command is generated (S903);

when the management host device is not successfully connected, determining again whether the startup command is generated (S903).

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the tell is in which the appended claims are expressed.

What is claimed is:

1. A management method for controlling at least one target device, executed by a management host device, and comprising the following steps:
executing a normal mode;
in the normal mode, resetting time of a timing unit, and turning on the timing unit to start timing;
broadcasting a first connection signal, wherein the first connection signal includes a first connection tag;
determining whether the time of the timing unit exceeds a first preset time period;
when the time of the timing unit exceeds the first preset time period, executing a temporary mode instead;
in the temporary mode, resetting the time of the timing unit, and turning on the timing unit to start timing;
in the temporary mode, stopping broadcasting the first connection signal, and broadcasting a second connection signal instead; wherein the second connection signal includes a second connection tag;
determining whether a resume command is received from at least one mobile device; wherein
when the resume command is received, executing the normal mode instead;
when the resume command is not received, determining whether the time of the timing unit exceeds a second preset time period; wherein
when the time of the timing unit does not exceed the second preset time period, continuously broadcasting the second connection signal, and determining again whether the resume command is received;
when the time of the timing unit exceeds the second preset time period, executing an unmanned mode instead;
wherein
in the normal mode, generating at least one normal mode control signal to control a startup state of the at least one target device;
in the unmanned mode, generating at least one unmanned mode control signal to change the startup state of the at least one target device;
in the normal mode, when the time of the timing unit does not exceed the first preset time period, continuously broadcasting the first connection signal, and determining again whether the time of the timing unit exceeds the first preset time period.

2. The management method as claimed in claim 1, further comprising the following steps:
in the unmanned mode, broadcasting a third connection signal, and determining whether the resume command is received; wherein
when the resume command is received, executing the normal mode instead;
when the resume command is not received, continuously broadcasting the third connection signal.

3. The management method as claimed in claim 1, further comprising the following steps:
in the unmanned mode, broadcasting the second connection signal, and determining whether the resume command is received; wherein
when the resume command is received, transmitting a reset signal to the at least one mobile device, and executing the nom al mode instead;
when the resume command is not received, continuously broadcasting the second connection signal.

4. The management method as claimed in claim 3, further comprising a connection procedure, wherein the connection procedure comprises the following steps:
determining whether a host registration procedure needs to be executed;
when the host registration procedure needs to be executed, executing the host registration procedure to establish the connection to the at least one mobile device, and registering identity information of the at least one mobile device;
when the host registration procedure does not need to be executed, monitoring a request command broadcasted by the at least one mobile device;
determining whether the request command broadcasted by the at least one mobile device is received;
when the request command broadcasted by the at least one mobile device is received, determining whether the request command is authenticated according to the registered identity information of the at least one mobile device;
when the request command is not received, monitoring again the request command broadcasted by the at least one mobile device;
when the request command broadcasted by the at least one mobile device is not authenticated, monitoring again the request command broadcasted by the at least one mobile device;
when the request command has been authenticated, establishing the connection to the at least one mobile device.

5. The management method as claimed in claim 3, further comprising a connection procedure, wherein the connection procedure comprises the following steps:
determining whether a host registration procedure needs to be executed;
when the host registration procedure needs to be executed, executing the host registration procedure to establish the connection to the at least one mobile device, and registering identity information of the at least one mobile device;
when the host registration procedure does not need to be executed, monitoring a request command broadcasted by the at least one mobile device;
determining whether the request command broadcasted by the at least one mobile device is received;
when the request command broadcasted by the at least one mobile device is received, determining whether the request command is authenticated according to the registered identity information of the at least one mobile device;
when the request command is not received, monitoring again the request command broadcasted by the at least one mobile device;
when the request command broadcasted by the at least one mobile device is not authenticated, monitoring again the request command broadcasted by the at least one mobile device;
when the request command has been authenticated, establishing the connection to the at least one mobile device, generating the resume command, ending the connection to the at least one mobile device, and monitoring again the request command broadcasted by the at least one mobile device to determine whether the request command is received.

6. A management system for controlling at least one target device, comprising:
at least one mobile device;
a management host device comprising a timing unit;
wherein when the management host device executes a normal mode, the management host device resets time of the timing unit, turns on the timing unit to start timing, and broadcasts a first connection signal;
wherein the management host device further determines whether the time of the timing unit exceeds a first preset time period;
wherein when the management host device executes the normal mode, and when the management host device determines that the time of the timing unit exceeds the first preset time period, the management host device executes a temporary mode instead;
wherein the first connection signal includes a first connection tag;
wherein when the management host device executes the temporary mode, the management host device resets the time of the timing unit, turns on the timing unit to start timing, and stops broadcasting the first connection signal to broadcast a second connection signal;
wherein the management host device further determines whether a resume command transmitted by the at least one mobile device is received;
wherein the second connection signal includes a second connection tag;
wherein when the management host device executes the temporary mode, and when the management host device receives the resume command, the management host device executes the normal mode instead;
wherein when the management host device executes the temporary mode, and when the management host device does not receive the resume command, the management host device determines whether the time of the timing unit exceeds a second preset time period;
wherein when the management host device executes the temporary mode, and when the management host device determines that the time of the timing unit does not exceed the second preset time period, the management host device broadcasts again the second connection signal, and determines again whether the resume command is received;
wherein when the management host device executes the temporary mode, and when the management host device determines that the time of the timing unit exceeds the second preset time period, the management host device executes an unmanned mode instead;
wherein when the management host device executes the normal mode, the management host device generates at least one normal mode control signal to control a startup state of the at least one target device;
wherein when the management host device executes the unmanned mode, the management host device generates at least one unmanned mode control signal to change the startup state of the at least one target device;
wherein when the management host device executes the normal mode, and when the management host device determines that the time of the timing unit does not exceed the first preset time period, the management host device
broadcasts again the first connection signal, and determines again whether the time of the timing unit exceeds the first preset time period.

7. The management system as claimed in claim 6, wherein
the management host device further executes a connection procedure;
when the management host device executes the connection procedure, the management host device determines whether a host registration procedure needs to be executed;
when the management host device determines that the host registration procedure needs to be executed, the management host device executes the host registration procedure to establish the connection to the at least one mobile device, and to register identity information of the at least one mobile device in the management host device;
when the management host device determines that the host registration procedure does not need to be executed, the management host device monitors a request command broadcasted by the at least one mobile device to determine whether the request command broadcast by the at least one mobile device is received;
when the management host device receives the request command broadcasted by the at least one mobile device, the management host device determines whether the request command broadcasted by the at least one mobile device is authenticated according to the identity information of the at least one mobile device registered in the management host device;
when the management host device determines that the request command broadcasted by the at least one mobile device has been authenticated, the management host device establishes the connection to the at least one mobile device, and the management host device receives the resume command transmitted by the at least one mobile device.

8. The management system as claimed in claim 7, wherein
when the management host device executes the connection procedure, and when the management host device establishes the connection to the at least one mobile device, the at least one mobile device turns on a connection timing unit of the management host device to start timing, receives the resume command transmitted by the at least one mobile device, and determines whether time of the connection timing unit exceeds a third preset time period;
when the management host device determines that the time of the connection timing unit exceeds the third preset time period, the management host device ends the connection to the at least one mobile device, and the management host device resets the time of the connection timing unit.

9. The management system as claimed in claim 6, wherein
the management host device further executes a connection procedure;
when the management host device executes the connection procedure, the management host device determines whether a host registration procedure needs to be executed;
when the management host device determines that the host registration procedure needs to be executed, the management host device executes the host registration procedure to establish the connection to the at least one mobile device, and to register identity information of the at least one mobile device in the management host device;
when the management host device determines that the host registration procedure does not need to be executed, the management host device monitors the request command broadcasted by the at least one mobile device, and the management host device determines whether a request command broadcast by the at least one mobile device is received;
when the management host device receives the request command broadcasted by the at least one mobile device, the management host device determines whether the request command broadcasted by the at least one mobile device is authenticated according to the identity information of the at least one mobile device registered in the management host device;
when the management host device determines that the request command broadcasted by the at least one mobile device has been authenticated, the management host device establishes the connection to the at least one mobile device, and the management host device generates the resume command.

10. The management system as claimed in claim 9, wherein
when the management host device executes the connection procedure, and when the management host device generates the resume command, the management host device ends the connection to the at least one mobile device, and the management host device monitors the request command broadcasted by the at least one mobile device to determine whether the request command broadcast by the at least one mobile device is received.

11. The management system as claimed in claim 7, wherein the host registration procedure executed by the management host device comprises the following steps:
closing a white list;
resetting time of the timing unit;
turning on the timing unit to start timing;
broadcasting an open registration signal; wherein the open registration signal includes an open registration tag;
determining whether the at least one mobile device is connected;
when the at least one mobile device is connected, determining whether a success registration command transmitted by the at least one mobile device is received;
when the success registration command transmitted by the at least one mobile device is received, registering the at least one mobile device, adding the at least one mobile device into the white list, opening the white list, and ending the host registration procedure;
when the at least one mobile device is not connected, determining whether the time of the connection timing unit exceeds a fourth preset time period;
when the time of the connection timing unit exceeds the fourth preset time period, opening the white list, and ending the host registration procedure.

12. The management system as claimed in claim 6, wherein
when the management host device executes the unmanned mode, the management host device broadcasts a third connection signal, and the management host device determines whether the resume command is received;
the third connection signal includes a third connection tag;
when the management host device executes the unmanned mode, and when the management host device receives the resume command, the management host device executes the normal mode instead;
when the management host device executes the unmanned mode, and when the management host device does not receive the resume command, the management host device broadcasts again the third connection signal.

13. The management system as claimed in claim 12, wherein
the at least one mobile device executes a management procedure;
when the at least one mobile device executes the management procedure, the at least one mobile device determines whether the second connection signal broadcasted by the management host device is received;
when the at least one mobile device determines that the second connection signal broadcasted by the management host device is received, the at least one mobile device broadcasts a request command to establish a connection to the management host device, and the at least one mobile device determines whether the at least one mobile device is successfully connected to the management host device;
when the at least one mobile device is successfully connected to the management host device, the at least one mobile device transmits the resume command to the management host device, and the at least one mobile device ends the connection to the management host device.

14. The management system as claimed in claim 13, wherein
the at least one mobile device determines whether a device registration procedure needs to be executed before the at least one mobile device determines whether the second connection signal is received;
when the at least one mobile device determines that the device registration procedure needs to be executed, the at least one mobile device executes the device registration procedure to establish a connection to the management host device, and to register identity information of the management host device in the at least one mobile device;
when the at least one mobile device determines that the device registration procedure does not need to be executed, the at least one mobile device determines whether a startup command is generated;
when the at least one mobile device determines that the startup command is generated, the at least one mobile device determines whether the second connection signal is received;
when the at least one mobile device receives the second connection signal, the at least one mobile device determines whether the second connection signal is authenticated by comparing the identity information included in the second connection signal and the identity information registered in the at least one mobile device;
when the at least one mobile device determines that the second connection signal has been authenticated,
the at least one mobile device broadcasts the request command to establish the connection to the management host device, and the at least one mobile device determines whether the management host device is successfully connected;
when the at least one mobile device is successfully connected with the management host device, the at least one mobile device transmits the resume command to the management host device, and the at least one mobile device ends the connection to the management host.

15. The management system as claimed in claim 13, wherein
when the at least one mobile device does not receive the second connection signal broadcasted by the management host, the at least one mobile device determines whether the third connection signal broadcasted by the management host device is received;
when the at least one mobile device receives the third connection signal, the at least one mobile device determines whether the third connection signal is authenticated according to the registered identity information of the management host device;
when the at least one mobile device determines that the third connection signal has been authenticated, the at least one mobile device establishes a connection to the management host device, and the at least one mobile device determines whether the management host device is successfully connected;
when the at least one mobile device determines that the management host device is successfully connected, the at least one mobile device transmits the resume command to the management host device, and the at least one mobile device ends the connection to the management host device.

16. The management system as claimed in claim 6, wherein
when the management host device executes the unmanned mode, the management host device broadcasts the second connection signal, and the management host device determines whether the resume command is received;
when the management host device executes the unmanned mode, and when the management host device receives the resume command, the management host device transmits a reset signal to the at least one mobile device, and the management host device executes the normal mode instead;
when the management host device executes the unmanned mode, and when the resume command is not received, the management host device broadcasts again the second connection signal.

17. The management system as claimed in claim 16, wherein
the at least one mobile device executes a management procedure;
when the at least one mobile device executes the management procedure, the at least one mobile device determines whether a device registration procedure needs to be executed;
when the at least one mobile device determines that the device registration procedure needs to be executed, the at least one mobile device executes the device registration procedure to establish the connection to the management host device, and registers identity information of the management host device;
when the at least one mobile device determines that the host registration procedure does not need to be executed, the at least one mobile device determines whether a startup command is generated;
when the at least one mobile device determines that the startup command is generated, the at least one mobile device determines whether the second connection signal broadcasted by the management host device is received;
when the at least one mobile device determines that the second connection signal is received, the at least one mobile device determines whether the second connection signal is authenticated according to the registered identity information of the management host device;
when the at least one mobile device determines that the second connection signal has been authenticated, the at least one mobile device broadcasts the request command, the at least one mobile device establishes a connection to the management host device, and the at least one mobile device determines whether the management host device is successfully connected;
when the at least one mobile device determines that the management host device is successfully connected, the at least one mobile device transmits the resume command to the management host device, and the at least one mobile device determines whether the reset signal is received.

18. The management system as claimed in claim 14, wherein the device registration procedure executed by the at least one mobile device comprises the following steps:
turning on a device timing unit to start timing;
determining whether time of the device timing unit exceeds a fifth preset time period;
when the time of the device timing unit does not exceed the fifth preset time period, determining whether an open registration signal broadcasted by the management host device is received;
when the open registration signal broadcasted by the management host device is received, determining whether the management host device is on a registration list;
when the management host device is not on the registration list, determining whether the management host device is successfully connected;
when the management host device is successfully connected, registering the management host device, and determining whether the management host device is successfully registered;
when the management host device is successfully registered, adding the management host device to the registration list, transmitting the success registration command, ending the connection to the management host device, and ending the device registration procedure;
when the time of the device timing unit exceeds the fifth preset time period, ending the device registration procedure.
